(19) United States
(12) Patent Application Publication
(10) Pub. No.: US 2022/0101257 A1
(43) Pub. Date: Mar. 31, 2022

(54) AUTOMATIC DYNAMIC DEMAND SHAPING

(71) Applicant: Walmart Apollo, LLC, Bentonville, AR (US)

(72) Inventors: Vineet Wason, San Jose, CA (US); Austin Lee Smith, San Jose, CA (US); Vidyanand Krishnan, Sunnyvale, CA (US); Puneet Srivastava, Fremont, CA (US); Yiren Ye, Milpitas, CA (US); Nitish Sarin, Gurgaon (IN); Benyi Gong, Sunnyvale, CA (US)

(73) Assignee: Walmart Apollo, LLC, Bentonville, AR (US)

(21) Appl. No.: 17/032,829

(22) Filed: Sep. 25, 2020

(51) Int. Cl. G06Q 10/08; G06Q 30/02

(52) U.S. Cl. CPC G06Q 10/0836; G06Q 10/0838; G06Q 30/0206; G06Q 30/0283

(57) ABSTRACT

A method including facilitating display of a first user interface to a controller. The first user interface can include fields that allow the controller to specify customizable parameters for shaping demand. The acts also can include receiving the customizable parameters from the controller. The acts additionally can include generating a historic utilization ranking corresponding to pickup time slots. The acts further can include determining in real-time a respective current utilization of each respective time slot of the pickup time slots. The acts additionally can include assigning the each respective time slot to a respective usage tier of usage tiers based at least in part on (1) a respective rank of the historic utilization ranking for the each respective time slot, (2) the respective current utilization of the each respective time slot, and (3) the customizable parameters. The acts further can include facilitating display of a second user interface to a customer. The second user interface can include a listing of at least a portion of the pickup time slots and usage indicators associated with individual time slots of the portion of the pickup time slots. The usage indicators can be associated with the individual time slots based on the respective usage tier to which each of the individual time slots have been assigned. Other embodiments are disclosed.

### TECHNICAL FIELD

This disclosure relates generally to automatic dynamic demand shaping.

### BACKGROUND

Some retailers offer users the option to order items online and pick up the items at a physical retail location. For example, some retailer offer online grocery ordering, in which users order groceries online and pick up the grocery order at a grocery store of the retailer. When a user chooses to pick up an online order at a retail location, the user typically designates a time to pick up the order.

### BRIEF DESCRIPTION OF THE DRAWINGS

To facilitate further description of the embodiments, the following drawings are provided in which:

FIG. 1 illustrates a front elevational view of a computer system that is suitable for implementing an embodiment of the system disclosed in FIG. 3;

FIG. 2 illustrates a representative block diagram of an example of the elements included in the circuit boards inside a chassis of the computer system of FIG. 1;

FIG. 3 illustrates a block diagram of a system that can be employed for automatic dynamic demand shaping, according to an embodiment;

FIG. 4 illustrates a flow chart for a method, according to an embodiment;

FIG. 5 illustrates an exemplary user interface display to allow the user of FIG. 3, such as a controller, to customize the demand shaping system of FIG. 3;

FIG. 6 illustrates a heat map showing utilization at each pickup time slot during a week for a retail location;

FIG. 7 illustrates an exemplary user interface display to allow the user of FIG. 3, such as a customer, to select a pickup time slot;

FIG. 8 illustrates a heat map showing historic utilization for each pickup time slot during a particular week for a particular retail store location;

FIG. 9 illustrates a table showing the historic utilization ranking for the time slots shown in the heat map of FIG. 8;

FIG. 10 illustrates a table showing the historic utilization ranking shown in the table of FIG. 9, with the time slots having low historic utilization highlighted;

FIG. 11 illustrates a table showing the current utilization of the same time slots that were shown in FIGS. 8-10, with the time slots having high current utilization highlighted;

FIG. 12 illustrates a table 1200 showing the time slots of FIG. 11 that are assigned to a first usage tier with a usage indicator of “Less Busy”;

FIG. 13A illustrates a heat map showing historic utilization for each pickup time slot during a particular week for a particular retail store location before using the techniques described herein; and

FIG. 13B illustrates a heat map showing historic utilization for each pickup time slot during a particular week for the retail store location after using the techniques described herein for more than four weeks.

For simplicity and clarity of illustration, the drawing figures illustrate the general manner of construction, and descriptions and details of well-known features and techniques may be omitted to avoid unnecessarily obscuring the present disclosure. Additionally, elements in the drawing figures are not necessarily drawn to scale. For example, the dimensions of some of the elements in the figures may be exaggerated relative to other elements to help improve understanding of embodiments of the present disclosure. The same reference numerals in different figures denote the same elements.

The terms “first,” “second,” “third,” “fourth,” and the like in the description and in the claims, if any, are used for distinguishing between similar elements and not necessarily for describing a particular sequential or chronological order. It is to be understood that the terms so used are interchangeable under appropriate circumstances such that the embodiments described herein are, for example, capable of operation in sequences other than those illustrated or otherwise described herein. Furthermore, the terms “include,” and “have,” and any variations thereof, are intended to cover a non-exclusive inclusion, such that a process, method, system, article, device, or apparatus that comprises a list of elements is not necessarily limited to those elements, but may include other elements not expressly listed or inherent to such process, method, system, article, device, or apparatus.

The terms “left,” “right,” “front,” “back,” “top,” “bottom,” “over,” “under,” and the like in the description and in the claims, if any, are used for descriptive purposes and not necessarily for describing permanent relative positions. It is to be understood that the terms so used are interchangeable under appropriate circumstances such that the embodiments of the apparatus, methods, and/or articles of manufacture described herein are, for example, capable of operation in other orientations than those illustrated or otherwise described herein.

The terms “couple,” “coupled,” “couples,” “coupling,” and the like should be broadly understood and refer to connecting two or more elements mechanically and/or otherwise. Two or more electrical elements may be electrically coupled together, but not be mechanically or otherwise coupled together. Coupling may be for any length of time, e.g., permanent or semi-permanent or only for an instant. “Electrical coupling” and the like should be broadly understood and include electrical coupling of all types. The absence of the word “removably,” “removable,” and the like near the word “coupled,” and the like does not mean that the coupling, etc. in question is or is not removable.

As defined herein, two or more elements are “integral” if they are comprised of the same piece of material. As defined herein, two or more elements are “non-integral” if each is comprised of a different piece of material.

As defined herein, “approximately” can, in some embodiments, mean within plus or minus ten percent of the stated value. In other embodiments, “approximately” can mean within plus or minus five percent of the stated value. In further embodiments, “approximately” can mean within plus or minus three percent of the stated value. In yet other embodiments, “approximately” can mean within plus or minus one percent of the stated value.

As defined herein, “real-time” can, in some embodiments, be defined with respect to operations carried out as soon as practically possible upon occurrence of a triggering event. A triggering event can include receipt of data necessary to execute a task or to otherwise process information. Because of delays inherent in transmission and/or in computing speeds, the term “real-time” encompasses operations that occur in “near” real-time or somewhat delayed from a triggering event. In a number of embodiments, “real-time” can mean real-time less a time delay for processing (e.g., determining) and/or transmitting data. The particular time delay can vary depending on the type and/or amount of the data, the processing speeds of the hardware, the transmission capability of the communication hardware, the transmission distance, etc. However, in many embodiments, the time delay can be less than approximately 0.1 second, 0.5 second, one second, two seconds, five seconds, or ten seconds.

### DESCRIPTION OF EXAMPLES OF EMBODIMENTS

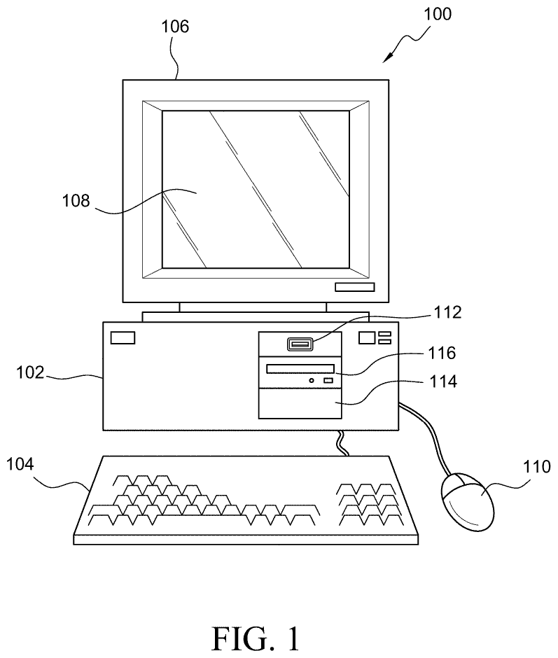

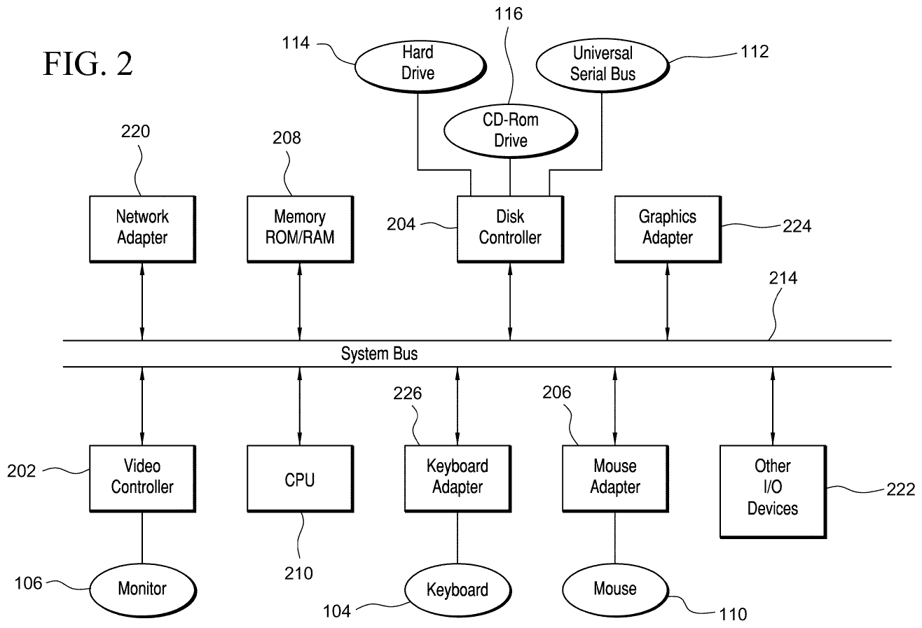

Turning to the drawings, FIG. 1 illustrates an exemplary embodiment of a computer system 100, all of which or a portion of which can be suitable for (i) implementing part or all of one or more embodiments of the techniques, methods, and systems and/or (ii) implementing and/or operating part or all of one or more embodiments of the non-transitory computer readable media described herein. As an example, a different or separate one of computer system 100 (and its internal components, or one or more elements of computer system 100) can be suitable for implementing part or all of the techniques described herein. Computer system 100 can comprise chassis 102 containing one or more circuit boards (not shown), a Universal Serial Bus (USB) port 112, a Compact Disc Read-Only Memory (CD-ROM) and/or Digital Video Disc (DVD) drive 116, and a hard drive 114. A representative block diagram of the elements included on the circuit boards inside chassis 102 is shown in FIG. 2. A central processing unit (CPU) 210 in FIG. 2 is coupled to a system bus 214 in FIG. 2. In various embodiments, the architecture of CPU 210 can be compliant with any of a variety of commercially distributed architecture families.

Continuing with FIG. 2, system bus 214 also is coupled to memory storage unit 208 that includes both read only memory (ROM) and random access memory (RAM). Non-volatile portions of memory storage unit 208 or the ROM can be encoded with a boot code sequence suitable for restoring computer system 100 (FIG. 1) to a functional state after a system reset. In addition, memory storage unit 208 can include microcode such as a Basic Input-Output System (BIOS). In some examples, the one or more memory storage units of the various embodiments disclosed herein can include memory storage unit 208, a USB-equipped electronic device (e.g., an external memory storage unit (not shown) coupled to universal serial bus (USB) port 112 (FIGS. 1-2)), hard drive 114 (FIGS. 1-2), and/or CD-ROM, DVD, Blu-Ray, or other suitable media, such as media configured to be used in CD-ROM and/or DVD drive 116 (FIGS. 1-2). Non-volatile or non-transitory memory storage unit(s) refer to the portions of the memory storage units(s) that are non-volatile memory and not a transitory signal. In the same or different examples, the one or more memory storage units of the various embodiments disclosed herein can include an operating system, which can be a software program that manages the hardware and software resources of a computer and/or a computer network. The operating system can perform basic tasks such as, for example, controlling and allocating memory, prioritizing the processing of instructions, controlling input and output devices, facilitating networking, and managing files. Exemplary operating systems can include one or more of the following: (i) Microsoft® Windows® operating system (OS) by Microsoft Corp. of Redmond, Wash., United States of America, (ii) Mac® OS X by Apple Inc. of Cupertino, Calif., United States of America, (iii) UNIX® OS, and (iv) Linux® OS. Further exemplary operating systems can comprise one of the following: (i) the iOS® operating system by Apple Inc. of Cupertino, Calif., United States of America, (ii) the Blackberry® operating system by Research In Motion (RIM) of Waterloo, Ontario, Canada, (iii) the WebOS operating system by LG Electronics of Seoul, South Korea, (iv) the Android™ operating system developed by Google, of Mountain View, Calif., United States of America, or (v) the Windows Mobile™ operating system by Microsoft Corp. of Redmond, Wash., United States of America.

As used herein, “processor” and/or “processing module” means any type of computational circuit, such as but not limited to a microprocessor, a microcontroller, a controller, a complex instruction set computing (CISC) microprocessor, a reduced instruction set computing (RISC) microprocessor, a very long instruction word (VLIW) microprocessor, a graphics processor, a digital signal processor, or any other type of processor or processing circuit capable of performing the desired functions. In some examples, the one or more processors of the various embodiments disclosed herein can comprise CPU 210.

In the depicted embodiment of FIG. 2, various I/O devices such as a disk controller 204, a graphics adapter 224, a video controller 202, a keyboard adapter 226, a mouse adapter 206, a network adapter 220, and other I/O devices 222 can be coupled to system bus 214. Keyboard adapter 226 and mouse adapter 206 are coupled to a keyboard 104 (FIGS. 1-2) and a mouse 110 (FIGS. 1-2), respectively, of computer system 100 (FIG. 1). While graphics adapter 224 and video controller 202 are indicated as distinct units in FIG. 2, video controller 202 can be integrated into graphics adapter 224, or vice versa in other embodiments. Video controller 202 is suitable for refreshing a monitor 106 (FIGS. 1-2) to display images on a screen 108 (FIG. 1) of computer system 100 (FIG. 1). Disk controller 204 can control hard drive 114 (FIGS. 1-2), USB port 112 (FIGS. 1-2), and CD-ROM and/or DVD drive 116 (FIGS. 1-2). In other embodiments, distinct units can be used to control each of these devices separately.

In some embodiments, network adapter 220 can comprise and/or be implemented as a WNIC (wireless network interface controller) card (not shown) plugged or coupled to an expansion port (not shown) in computer system 100 (FIG. 1). In other embodiments, the WNIC card can be a wireless network card built into computer system 100 (FIG. 1). A wireless network adapter can be built into computer system 100 (FIG. 1) by having wireless communication capabilities integrated into the motherboard chipset (not shown), or implemented via one or more dedicated wireless communication chips (not shown), connected through a PCI (peripheral component interconnector) or a PCI express bus of computer system 100 (FIG. 1) or USB port 112 (FIG. 1). In other embodiments, network adapter 220 can comprise and/or be implemented as a wired network interface controller card (not shown).

Although many other components of computer system 100 (FIG. 1) are not shown, such components and their interconnection are well known to those of ordinary skill in the art. Accordingly, further details concerning the construction and composition of computer system 100 (FIG. 1) and the circuit boards inside chassis 102 (FIG. 1) are not discussed herein.

When computer system 100 in FIG. 1 is running, program instructions stored on a USB drive in USB port 112, on a CD-ROM or DVD in CD-ROM and/or DVD drive 116, on hard drive 114, or in memory storage unit 208 (FIG. 2) are executed by CPU 210 (FIG. 2). A portion of the program instructions, stored on these devices, can be suitable for carrying out all or at least part of the techniques described herein. In various embodiments, computer system 100 can be reprogrammed with one or more modules, system, applications, and/or databases, such as those described herein, to convert a general purpose computer to a special purpose computer. For purposes of illustration, programs and other executable program components are shown herein as discrete systems, although it is understood that such programs and components may reside at various times in different storage components of computing device 100, and can be executed by CPU 210. Alternatively, or in addition to, the systems and procedures described herein can be implemented in hardware, or a combination of hardware, software, and/or firmware. For example, one or more application specific integrated circuits (ASICs) can be programmed to carry out one or more of the systems and procedures described herein. For example, one or more of the programs and/or executable program components described herein can be implemented in one or more ASICs.

Although computer system 100 is illustrated as a desktop computer in FIG. 1, there can be examples where computer system 100 may take a different form factor while still having functional elements similar to those described for computer system 100. In some embodiments, computer system 100 may comprise a single computer, a single server, or a cluster or collection of computers or servers, or a cloud of computers or servers. Typically, a cluster or collection of servers can be used when the demand on computer system 100 exceeds the reasonable capability of a single server or computer. In certain embodiments, computer system 100 may comprise a portable computer, such as a laptop computer. In certain other embodiments, computer system 100 may comprise a mobile device, such as a smartphone. In certain additional embodiments, computer system 100 may comprise an embedded system.

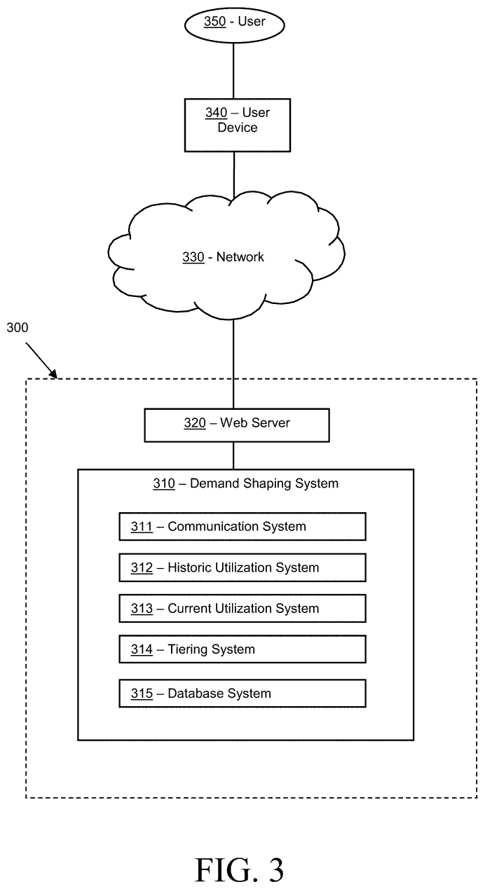

Turning ahead in the drawings, FIG. 3 illustrates a block diagram of a system 300 that can be employed for automatic dynamic demand shaping, according to an embodiment. System 300 is merely exemplary and embodiments of the system are not limited to the embodiments presented herein. The system can be employed in many different embodiments or examples not specifically depicted or described herein. In some embodiments, certain elements, modules, or systems of system 300 can perform various procedures, processes, and/or activities. In other embodiments, the procedures, processes, and/or activities can be performed by other suitable elements, modules, or systems of system 300. In some embodiments, system 300 can include a demand shaping system 310 and/or web server 320.

Generally, therefore, system 300 can be implemented with hardware and/or software, as described herein. In some embodiments, part or all of the hardware and/or software can be conventional, while in these or other embodiments, part or all of the hardware and/or software can be customized (e.g., optimized) for implementing part or all of the functionality of system 300 described herein.

Demand shaping system 310 and/or web server 320 can each be a computer system, such as computer system 100 (FIG. 1), as described above, and can each be a single computer, a single server, or a cluster or collection of computers or servers, or a cloud of computers or servers. In another embodiment, a single computer system can host demand shaping system 310 and/or web server 320. Additional details regarding demand shaping system 310 and/or web server 320 are described herein.

In some embodiments, web server 320 can be in data communication through a network 330 with one or more user devices, such as a user device 340. User device 340 can be part of system 300 or external to system 300. Network 330 can be the Internet or another suitable network. In some embodiments, user device 340 can be used by users, such as a user 350. In many embodiments, web server 320 can host one or more websites and/or mobile application servers. For example, web server 320 can host a website, or provide a server that interfaces with an application (e.g., a mobile application), on user device 340, which can allow users (e.g., 350) to browse and/or search for items (e.g., products, grocery items), to add items to an electronic cart, to purchase items, to request pickup (e.g., grocery pickup), and/or to request delivery (e.g., grocery delivery), in addition to other suitable activities. In a number of embodiments, web server 320 can interface with demand shaping system 310 when a user (e.g., 350), such as a customer, requests pickup or delivery.

In a number of embodiments, web server 320 can host a website, or provide a server that interfaces with an application, on user device 340, which can allow other users (e.g., 350), such as business users, to interface with demand shaping system 310, to allow such users to enter parameters, settings, and/or other information in demand shaping system 310 to customize the manner in which demand shaping system 310 operates. These business users can be referred to herein as controllers, based on their operation in controlling the customization of demand shaping system 310.

In some embodiments, an internal network that is not open to the public can be used for communications between demand shaping system 310 and web server 320 within system 300. Accordingly, in some embodiments, demand shaping system 310 (and/or the software used by such systems) can refer to a back end of system 300 operated by an operator and/or administrator of system 300, and web server 320 (and/or the software used by such systems) can refer to a front end of system 300, as is can be accessed and/or used by one or more users, such as user 350, using user device 340. In these or other embodiments, the operator and/or administrator of system 300 can manage system 300, the processor(s) of system 300, and/or the memory storage unit(s) of system 300 using the input device(s) and/or display device(s) of system 300. In some embodiments, the controllers can operate (e.g., customize) demand shaping system 310 without using web server 320.

In certain embodiments, the user devices (e.g., user device 340) can be desktop computers, laptop computers, mobile devices, and/or other endpoint devices used by one or more users (e.g., user 350). A mobile device can refer to a portable electronic device (e.g., an electronic device easily conveyable by hand by a person of average size) with the capability to present audio and/or visual data (e.g., text, images, videos, music, etc.). For example, a mobile device can include at least one of a digital media player, a cellular telephone (e.g., a smartphone), a personal digital assistant, a handheld digital computer device (e.g., a tablet personal computer device), a laptop computer device (e.g., a notebook computer device, a netbook computer device), a wearable user computer device, or another portable computer device with the capability to present audio and/or visual data (e.g., images, videos, music, etc.). Thus, in many examples, a mobile device can include a volume and/or weight sufficiently small as to permit the mobile device to be easily conveyable by hand. For examples, in some embodiments, a mobile device can occupy a volume of less than or equal to approximately 1790 cubic centimeters, 2434 cubic centimeters, 2876 cubic centimeters, 4056 cubic centimeters, and/or 5752 cubic centimeters. Further, in these embodiments, a mobile device can weigh less than or equal to 15.6 Newtons, 17.8 Newtons, 22.3 Newtons, 31.2 Newtons, and/or 44.5 Newtons.

Exemplary mobile devices can include (i) an iPod®, iPhone®, iTouch®, iPad®, MacBook® or similar product by Apple Inc. of Cupertino, Calif., United States of America, (ii) a Blackberry® or similar product by Research in Motion (RIM) of Waterloo, Ontario, Canada, (iii) a Lumia® or similar product by the Nokia Corporation of Keilaniemi, Espoo, Finland, and/or (iv) a Galaxy™ or similar product by the Samsung Group of Samsung Town, Seoul, South Korea. Further, in the same or different embodiments, a mobile device can include an electronic device configured to implement one or more of (i) the iPhone® operating system by Apple Inc. of Cupertino, Calif., United States of America, (ii) the Blackberry® operating system by Research In Motion (RIM) of Waterloo, Ontario, Canada, (iii) the Android™ operating system developed by the Open Handset Alliance, or (iv) the Windows Mobile™ operating system by Microsoft Corp. of Redmond, Wash., United States of America.

In many embodiments, demand shaping system 310 and/or web server 320 can each include one or more input devices (e.g., one or more keyboards, one or more keypads, one or more pointing devices such as a computer mouse or computer mice, one or more touchscreen displays, a microphone, etc.), and/or can each comprise one or more display devices (e.g., one or more monitors, one or more touch screen displays, projectors, etc.). In these or other embodiments, one or more of the input device(s) can be similar or identical to keyboard 104 (FIG. 1) and/or a mouse 110 (FIG. 1). Further, one or more of the display device(s) can be similar or identical to monitor 106 (FIG. 1) and/or screen 108 (FIG. 1). The input device(s) and the display device(s) can be coupled to demand shaping system 310 and/or web server 320 in a wired manner and/or a wireless manner, and the coupling can be direct and/or indirect, as well as locally and/or remotely. As an example of an indirect manner (which may or may not also be a remote manner), a keyboard-video-mouse (KVM) switch can be used to couple the input device(s) and the display device(s) to the processor(s) and/or the memory storage unit(s). In some embodiments, the KVM switch also can be part of demand shaping system 310 and/or web server 320. In a similar manner, the processors and/or the non-transitory computer-readable media can be local and/or remote to each other.

Meanwhile, in many embodiments, demand shaping system 310 and/or web server 320 also can be configured to communicate with one or more databases, such as a database system 315. The one or more databases can include a product database that contains information about time slot utilization, capacity, parameters, settings, and/or other suitable information, as described below in further detail. The one or more databases can be stored on one or more memory storage units (e.g., non-transitory computer readable media), which can be similar or identical to the one or more memory storage units (e.g., non-transitory computer readable media) described above with respect to computer system 100 (FIG. 1). Also, in some embodiments, for any particular database of the one or more databases, that particular database can be stored on a single memory storage unit or the contents of that particular database can be spread across multiple ones of the memory storage units storing the one or more databases, depending on the size of the particular database and/or the storage capacity of the memory storage units.

The one or more databases can each include a structured (e.g., indexed) collection of data and can be managed by any suitable database management systems configured to define, create, query, organize, update, and manage database(s). Exemplary database management systems can include MySQL (Structured Query Language) Database, PostgreSQL Database, Microsoft SQL Server Database, Oracle Database, SAP (Systems, Applications, & Products) Database, and IBM DB2 Database.

Meanwhile, demand shaping system 310, web server 320, and/or the one or more databases can be implemented using any suitable manner of wired and/or wireless communication. Accordingly, system 300 can include any software and/or hardware components configured to implement the wired and/or wireless communication. Further, the wired and/or wireless communication can be implemented using any one or any combination of wired and/or wireless communication network topologies (e.g., ring, line, tree, bus, mesh, star, daisy chain, hybrid, etc.) and/or protocols (e.g., personal area network (PAN) protocol(s), local area network (LAN) protocol(s), wide area network (WAN) protocol(s), cellular network protocol(s), powerline network protocol(s), etc.). Exemplary PAN protocol(s) can include Bluetooth, Zigbee, Wireless Universal Serial Bus (USB), Z-Wave, etc.; exemplary LAN and/or WAN protocol(s) can include Institute of Electrical and Electronic Engineers (IEEE) 802.3 (also known as Ethernet), IEEE 802.11 (also known as WiFi), etc.; and exemplary wireless cellular network protocol(s) can include Global System for Mobile Communications (GSM), General Packet Radio Service (GPRS), Code Division Multiple Access (CDMA), Evolution-Data Optimized (EV-DO), Enhanced Data Rates for GSM Evolution (EDGE), Universal Mobile Telecommunications System (UMTS), Digital Enhanced Cordless Telecommunications (DECT), Digital AMPS (IS-136/Time Division Multiple Access (TDMA)), Integrated Digital Enhanced Network (iDEN), Evolved High-Speed Packet Access (HSPA+), Long-Term Evolution (LTE), WiMAX, etc. The specific communication software and/or hardware implemented can depend on the network topologies and/or protocols implemented, and vice versa. In many embodiments, exemplary communication hardware can include wired communication hardware including, for example, one or more data buses, such as, for example, universal serial bus(es), one or more networking cables, such as, for example, coaxial cable(s), optical fiber cable(s), and/or twisted pair cable(s), any other suitable data cable, etc. Further exemplary communication hardware can include wireless communication hardware including, for example, one or more radio transceivers, one or more infrared transceivers, etc. Additional exemplary communication hardware can include one or more networking components (e.g., modulator-demodulator components, gateway components, etc.).

In many embodiments, demand shaping system 310 can include a communication system 311, a historic utilization system 312, a current utilization system 313, a tiering system 314, and/or database 315. In many embodiments, the systems of demand shaping system 310 can be modules of computing instructions (e.g., software modules) stored at non-transitory computer readable media that operate on one or more processors. In other embodiments, the systems of demand shaping system 310 can be implemented in hardware. Demand shaping system 310 and/or web server 320 each can be a computer system, such as computer system 100 (FIG. 1), as described above, and can be a single computer, a single server, or a cluster or collection of computers or servers, or a cloud of computers or servers. In another embodiment, a single computer system can host demand shaping system 310 and/or web server 320. Additional details regarding demand shaping system 310 the components thereof are described herein.

Conventionally, when an online grocery customer places an order, the customer can be asked to choose a time slot for picking up the order from a retail store or having the order delivered to the home of the customer, such as through a delivery service that picks up the order from the retail store and delivers the order to the customer. Same day ordering has become increasingly popular. As the use of online ordering with retail pickup (e.g., online grocery) has increased, various time slots at various stores have become more popular than others. Demand has thus become clustered during peak pickup times, which has resulted in longer wait times or busy customers not being able to select pickup times that work best for them. For example, many customers tend to pick evening hours or weekend hours. The high popularity of such time slots and the capacity limits of retail store to handle processing of orders at each time slots can present challenges. For example, if a customer is trying to shop at the last minute, the customer is often not able to choose such popular time slots. And even if the customer is able to select a popular time slot, the customer often will wait significantly longer at the retail store due to higher wait times associated with such popular time slots. Some customers prefer to be able to place orders at the last minute and nonetheless still be able to select pickup and/or delivery times of their choice without paying more when selecting a popular time slot. Some customers will choose to order elsewhere if they cannot select a preferred pickup time, which can result in lost sales.

In a number of embodiments, demand shaping system 310 can be used to shape demand for online order pickup from one or more physical retail stores, which can held to improve the customer experience, support retail stores, and grow sales. In many embodiments, demand shaping system 310 can use historical and real-time data in decision trees, constraint-based modeling, and/or complex ranking algorithms. Demand shaping system 310 can beneficially provide the ability to balance demand on store operations, provide transparency, and/or increase same-day slot availability to customers. For example, in some embodiments, demand shaping system 310 can make significant changes to slot promise to address the challenges described above. Using historical and real time data in decision trees, constraint-based modeling, and complex ranking algorithms demand shaping system 310 can offer better promise and incentives, such as discounted price, low wait times, and/or an express options, which can advantageously smoothen demand on retail store operational resources and/or can provide transparency and increased same-day slot availability to the customer. By making customers aware of less busy time slots and/or incentivizing customers to use less busy time slots, the demand across time slots can become more balanced.

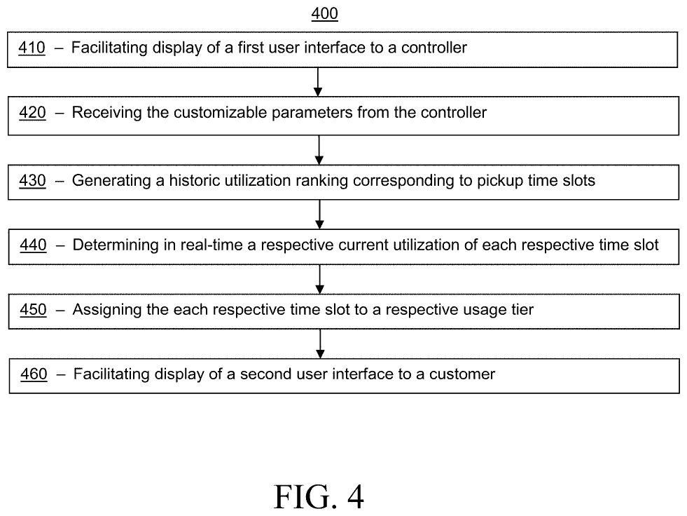

Turning ahead in the drawings, FIG. 4 illustrates a flow chart for a method 400, according to an embodiment. In some embodiments, method 400 can be a method of automatic dynamic demand shaping. Method 400 is merely exemplary and is not limited to the embodiments presented herein. Method 400 can be employed in many different embodiments or examples not specifically depicted or described herein. In some embodiments, the procedures, the processes, and/or the activities of method 400 can be performed in the order presented. In other embodiments, the procedures, the processes, and/or the activities of method 400 can be performed in any suitable order. In still other embodiments, one or more of the procedures, the processes, and/or the activities of method 400 can be combined or skipped.

In many embodiments, system 300 (FIG. 3), demand shaping system 310 (FIG. 3), and/or web server 320 (FIG. 3) can be suitable to perform method 400 and/or one or more of the activities of method 400. In these or other embodiments, one or more of the activities of method 400 can be implemented as one or more computing instructions configured to run at one or more processors and configured to be stored at one or more non-transitory computer readable media. Such non-transitory computer readable media can be part of system 300. The processor(s) can be similar or identical to the processor(s) described above with respect to computer system 100 (FIG. 1).

In some embodiments, method 400 and other activities in method 400 can include using a distributed network including distributed memory architecture to perform the associated activity. This distributed architecture can reduce the impact on the network and system resources to reduce congestion in bottlenecks while still allowing data to be accessible from a central location.

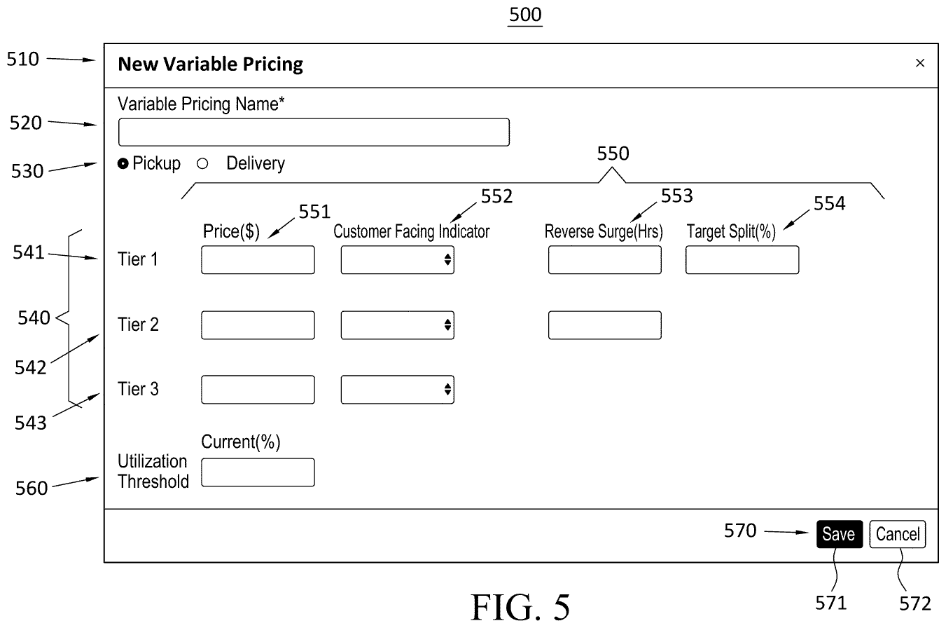

Referring to FIG. 4, method 400 can include an activity 410 of facilitating display of a first user interface to a controller. In many embodiments, the controller can be a user, such as user 350 (FIG. 3), which can control the customization of a demand shaping system, such as demand shaping system 310 (FIG. 3). For example, the controller can be a business user that can input parameters, settings, and/or other suitable controls into demand shaping system 310 (FIG. 3). In some embodiments, a display of the first user interface can be similar to user interface display 500 (FIG. 5), as described below in further detail. In a number of embodiments, the first user interface can include fields that allow the controller to specify customizable parameters for shaping demand. For example, the customizable parameters can include a target split for usage tiers, one or more reverse-surge time-duration thresholds, and/or a current utilization threshold. In some embodiments, the target split for usage tiers can be similar or identical to the target split entered in target split field 554, as shown in FIG. 5 and described below. In a number of embodiments, the reverse-surge time-duration thresholds can be similar or identical to the times entered in reverse surge fields 553, as shown in FIG. 5 and described below. In some embodiments, current utilization threshold can be similar or identical to the threshold entered in current utilization threshold field 560, as shown in FIG. 5 and described below.

In some embodiments, the usage tiers can include two or more tiers that stratify pickup time slots based on various factors, but can generally indicate a level of demand for the time slot in view of the capacity of the retail store to handle orders at the pickup time slot. For example, in some embodiments, there can be three usage tiers, in which tier one indicates that the time slot is “less busy,” tier two indicates that the time slot is “busy,” and tier three indicates that the time slot is “super busy.” In a number of embodiments, the first user interface further can include fields that allow the user to specify usage indicators and/or delivery-service pickup prices for the usage tiers. In a number of embodiments, the usage indicators can be similar or identical to the customer-facing indicators entered in customer-facing indicator fields 552, as shown in FIG. 5 and described below. In some embodiments, the delivery-service pickup prices can be similar or identical to the prices entered in price fields 551, as shown in FIG. 5 and described below.

Turning ahead in the drawings, FIG. 5 illustrates an exemplary user interface display 500 to allow user 350 (FIG. 3), such as a controller, to customize demand shaping system 310 (FIG. 3). User interface display 500 is merely exemplary, and embodiments of the user interface display are not limited to the embodiments presented herein. The user interface display can be employed in many different embodiments or examples not specifically depicted or described herein, and can include other suitable elements. In many embodiments, user device 340 (FIG. 3) can display user interface display 500 to user 350 (FIG. 3), which can include a form that allows the user to enter various inputs to customize demand shaping module 310 (FIG. 3).

In a number of embodiments, user interface display 500 can include a title bar 510, a naming field 520, a pickup type selector 530, tier rows 540, tier-based parameter fields 550, a current utilization threshold field 560, and/or completion buttons 570. In many embodiments, title bar 510 can provide a title and/or descriptor for the form shown in user interface display 500, such as “new variable pricing,” or another suitable title and/or descriptor. In several embodiments, naming field 520 can allow the controller to enter a name for a set of customizations entered using the form shown in user interface display 500. In some embodiments, the controller can enter multiple different sets of customizations, which each can be named for identifying and distinguishing between the different sets of customizations.

In some embodiments, pickup type selector 530 can allow the controller to select either pickup or delivery, to define the parameters that are used for the selected option. In some embodiments, the controller can first select a first option (e.g., pickup) and enter parameters for that first option, and then select the other option (e.g., delivery) and enter parameters for that other option. The parameters entered for the pickup option can apply when the customer is picking up the order at the retail store. The parameters entered for the delivery option can apply when the customer desires for a delivery service to pickup to order at the retail store and deliver the order to the residence (or other delivery location) of the customer.

In many embodiments, tier rows 540 can include a row for each usage tier, such as a tier row 541 for Tier 1, a tier row 542 for Tier 2, and/or a tier row 543 for Tier 3. In several embodiments, tier-based parameter fields 550 can include various input fields for parameters and/or settings related to the usage tiers. For example, tier-based parameter fields 550 can include price fields 551, customer-facing indicator fields 552, reverse surge fields 553, and/or a target split field 554.

In a number of embodiments, price fields 551 can allow the controller to input a price for each usage tier, or for one or more of the usage tiers. In some embodiments, the price can be used for both pickup and delivery. In other embodiments, the price can be used only for delivery or instead only for pickup. For example, the controller can input $7.95 as the delivery price for Tier 1, $9.95 as the delivery price for Tier 2, and/or $11.95 as the delivery price for Tier 3. Other prices can be entered by the controller to customize the operation of demand surge system 310 (FIG. 3). In many embodiments, the prices for a usage tier can be used when the customer selects a pickup time slot that is assigned to that usage tier.

In several embodiments, customer-facing indicator fields 552 can allow the controller to input an indicator to show to the customer for each usage tier, or for one or more of the usage tiers. For example, the controller can input “Less Busy” as the customer-facing indicator for Tier 1, “Busy” as the customer-facing indicator for Tier 2, and/or “Super Busy” as the customer-facing indicator for Tier 3. Other customer-facing indicators can be entered by the controller to customize the operation of demand surge system 310 (FIG. 3). In many embodiments, the customer-facing indicator for a usage tier can be displayed to the customer for the each time slot that is assigned to that usage tier.

In a number of embodiments, reverse surge fields 553 can allow the controller to input a time before closing of a time slot to lower the usage tier of the time slot in order to promote completely filling up the time slot before the time slot closes, even if the time slot is busy. For example, the controller can enter “0.5” for Tier 1 to indicate that a time slot in Tier 2 that is not completely filled within a half hour of closing will be lowered to Tier 1. As another example, the controller can enter “2” for Tier 2 to indicate that a time slot in Tier 3 that is not completely filled within 2 hours of closing will be lowered to Tier 2. Other reverse surge times can be entered by the controller to customize the operation of demand surge system 310 (FIG. 3). These reverse surge times can be referred to as reverse-surge time-duration thresholds.

In several embodiments, target split field 554 can allow the controller to input a desired split among the usage tiers, such as the percentage of time slots to be assigned as Tier 1. For example, the controller can enter “60” to indicate that 65% of the time slots should be categorized as Tier 1, and the remaining 40% of the slots can be categorized as Tier 2 or Tier 3. Other target split percentages can be entered by the controller to customize the operation of demand surge system 310 (FIG. 3). In some embodiments, a target split field (not shown) can be used for Tier 2 to indicate the percentage of time slots to be assigned to Tier 2. In other embodiments, target split field 554 for Tier 1 can be the only target split field included, as shown in user interface display 500. In many embodiments, the percentage entered in the target split field can be different between the pickup types (e.g., pickup and delivery). For example, the target split percentage can be set to 15% of pickup and 40% for delivery.

In many embodiments, current utilization threshold field 560 can allow the controller to input a threshold for current utilization. If the current utilization for a time slot is more than this threshold, the time slot can be reassigned to Tier 2 instead of Tier 1. For example, the controller can enter “80” to indicate that a time slot otherwise assigned to Tier 1 will be reassigned to Tier 2 if the utilization of the time slot is above 80%. Other current utilization thresholds can be entered by the controller to customize the operation of demand surge system 310 (FIG. 3).

In several embodiments, completion buttons 570 can include a save button 571 to allow the controller to save the parameters and/or settings entered into the form displayed in user interface display 500. In some embodiments, completion buttons 570 can include a cancel button 572 to allow the controller to cancel out and discard any parameters and/or settings entered into the form displayed in user interface display 500.

Returning to FIG. 4, in a number of embodiments, method 400 also can include an activity 420 of receiving the customizable parameters from the controller. For example, after the controller enters the customizable parameters in user interface display 500 (FIG. 5) and uses save button 571 (FIG. 5) to save those inputs, the customizable parameters can be received.

In several embodiments, method 400 additionally can include with an activity 430 of generating a historic utilization ranking corresponding to pickup time slots. In many embodiments, the historic utilization ranking can be generated weekly, or at another suitable interval. In several embodiments, the historic utilization ranking is generated based on a respective utilization of each respective time slot of the pickup time slots during previous time periods. In some embodiments, the previous time periods can be four or more weeks. In several embodiments, the respective utilization of the each respective time slot of the pickup time slots is determined based on a quantity of orders received for the each respective time slot during the previous time periods and an order capacity at the each respective time slot during the previous time periods. For example, the historic utilization for a time slot can be calculated as follows:

$$Historic Utilization = \frac{Number of Orders}{Capacity}$$

where the Number of Orders is the number of orders that were received for that time slot at the retail store on average during the previous time periods, and the Capacity is the planned capacity for the time slot, such as the maximum number of orders that the retail store was open to handling on average during the previous time periods. For example, at the Monday 4-5 pm time slot, if the average number of orders each week for that time slot for the last four weeks was 17.2 and the average capacity each week for that time slot for the last four weeks was 20.0, then the historic utilization for that time slot is 86%. The respective historic utilization for each time slot can be used to determine a ranking of the time slots, as described below in more detail.

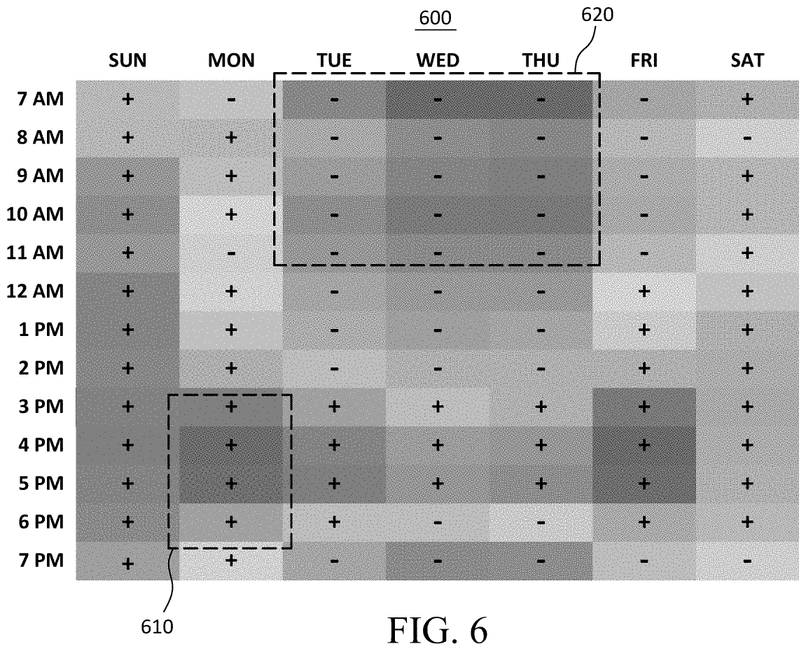

Turning ahead in the drawings, FIG. 6 illustrates a heat map 600 showing utilization at each pickup time slot during a week for a retail location. In many embodiments, as shown in heat map 600 each pickup time slot can be a one-hour time slot. In other embodiments, each pickup time slot can be a different suitable time period, such 15 minutes, 30 minutes, 45 minutes, 90 minutes, or 2 hours, for example. Heat map 600 can indicate a general level of utilization for each time slot. The time slots that are lower utilized include a “-” to indicate lower usage, with lighter shading indicating low utilization, and darker shading indicating even lower utilization. The time slot that are high utilized include a “+” to indicate higher usage, with lighter shading indicating high utilization and darker shading indicating even higher utilization. Heat map 600 shows how time slots at evening and weekends often have the highest utilization.

Consider a scenario of two different types of customers, namely an inflexible customer and a flexible customer who both want to pick up an order at Monday 4-5 pm, or shortly before or after that time, as shown in box 610. The inflexible customer, such as a busy working mom, can be very particular about a time slot at which she typically likes to pick up orders, such as always at Monday 4-5 pm. If she does not get this time slot of her choice, she will not shop with the retail store and could instead use a competitor. The flexible customer who also likes to shop at Monday 4-5 pm could be frustrated with high wait times and could be looking for alternate options offering shorter wait times. By making the flexible customer aware of less-busy time slots, such as those shown in box 620, and/or by incentivizing the flexible customer to use such less-busy time slots, the flexible customer could instead select such less-busy time slots, which could lead to lower wait times for the flexible customer. Additionally, because the flexible customer selected a less-busy time slot, such as a time slot in box 620, the busy time slots in box 610 can be more available for the inflexible customer.

The historic utilization for each time slot can be calculated as described above. Each of the time slots can then be ranked, such that the time slot with the highest utilization is ranked first as number 1. Table 1 shows an example of ranks for the top 42 time slots (top 50%) by historic utilization at a retail store. In many embodiments, the historic utilization ranking can include all of the time slots.

TABLE 1

| Time | Sun. | Mon. | Tue. | Wed. | Thu. | Fri. | Sat. |
|---|---|---|---|---|---|---|---|
| 8-9 am | 13 | 30 | | | | 33 | 8 |
| 9-10 am | 9 | 35 | | | | 41 | 5 |
| 10-11 am | 6 | | | | | | 11 |
| 11 am-12 pm | 17 | | | | | | 26 |
| 12-1 pm | 20 | | | | | | 37 |
| 1-2 pm | 23 | | | | | 42 | 38 |
| 2-3 pm | 24 | 40 | | | | 28 | 36 |
| 3-4 pm | 21 | 16 | 29 | 34 | 27 | 7 | 32 |
| 4-5 pm | 18 | 2 | 12 | 19 | 10 | 1 | 31 |
| 5-6 pm | 25 | 3 | 15 | 22 | 14 | 4 | |
| 6-7 pm | | 39 | | | | | |
| 7-8 pm | | | | | | | |

In some embodiments, the historic utilization ranking can be generated as an offline process once a week for all of the retail stores in an organization. For example, the historic utilization ranking can be performed each Saturday for the upcoming week. First, the historic ranks for a week for all the stores, if they exist, can be obtained. Second, orders and capacities at each time slot for each store for the last four weeks can be obtained. The information obtained in the first and second steps can be prepared in a message payload for each store. The message for each store can then posted using an asynchronous publish-subscribe model, such as Kafka, which can allow for parallel processing to be used to determine the rankings at multiple stores at the same time one different processors. Kafka consumers (e.g., processing nodes) can then process the messages using a ranking function for each store. In many embodiments, the ranking function can average the utilization at each time slot across the four weeks, then sort the time slots by average utilization in descending order, then assign a rank to each time slot starting at 1. The historic utilization ranking can then be persisted, such as in database 315 (FIG. 3).

In some embodiments, the time slots with a rank in the historic utilization ranking below a threshold percentage of all the ranks in the historic utilization ranking can be considered low historic utilization, and otherwise considered high historic utilization. For example, the bottom 15% of ranks can be considered low historic utilization for pickup, and the bottom 40% of ranks can be considered low historic utilization for delivery. These parameters can be customized by the controller adjusting the target split, as described above in connection with FIG. 5.

Returning to FIG. 4, in a number of embodiments, method 400 further can include an activity 440 of determining in real-time a respective current utilization of each respective time slot of the pickup time slots. In several embodiments, the respective current utilization of the each respective time slot of the pickup time slots can be determined based on a quantity of orders already received for the each respective time slot to be filled at the each respective time slot during an upcoming first time period and an order capacity at the each respective time slot during the upcoming first time period. In a number of embodiments, the upcoming first time period can be approximately one week, or another suitable time period. In many embodiments, the current utilization for a time slot can be calculated as follows:

$$Current Utilization = \frac{Number of Orders}{Capacity}$$

where the Number of Orders is the number of orders that have already been received for that time slot at the retail store for the upcoming week, and the Capacity is the planned capacity for the time slot, such as the maximum number of orders that the retail store is open to handling for that time slot for the upcoming week. In many embodiments, the current utilization can be determined in real-time before a customer is presented with time slots to select. For example, is some embodiments, when a customer selects an option in an ordering process that triggers presenting the time slots for the customer to select a time slot, the current utilization of the time slots to be presented can be determined.

In a number of embodiments, when the current utilization of a time slot exceeds a threshold, the time slot can be considered high current utilization, and then the time slot does not exceed the threshold, it can be considered low current utilization. For example, current utilization about 80% can be considered high current utilization. These parameters can be customized by the controller adjusting the current utilization threshold, as described above in connection with FIG. 5. In a number of embodiments, when the time slot only has one opening left in the time slot before it reaches the capacity limit, which can also be referred to as “last slot,” the current utilization of the time slot can be considered super high current utilization.

In many embodiments, the current utilization information for each time slot also can include information about whether the time slot is closed or nearing closure. A time slot can close a predetermined amount of time before it begins, so that processing of the order assembly can be occur before the time slot begins. For example, a time slot can close 3 hours before it begins, so that a time slot on Monday at 11 am-12 pm will close at 8 am on Monday. In a number of embodiments, some time slots can close earlier than other time slots. For example, time slots in the evening can close 5 hours before they begin, while time slots in the morning can close 3 hours before they begin. Once a time slot is closed, it is no longer presented to the customer as a possible selection. Time slots that are nearing closure can be those time slots that are within an amount of time of closing. For example, a time slot that will close in the next 1 hour, or in the next 2 hours, as examples, can be nearing closure. The parameters for whether a time slot is nearing closure can be customized by the controller adjusting the reverse surge times, as described above in connection with FIG. 5.

As an example, for a customer ordering online at 7:30 on a particular day, the real-time statue of time slots at a retail store for the rest of that particular day can be as shown in Table 2, depending on the parameters set by the controller.

TABLE 2

| Time | Today |
|---|---|
| 8-9 am | Closed |
| 9-10 am | Closed |
| 10-11 am | Closed |
| 11 am-12 pm | Nearing closure |
| 12-1 pm | High current utilization |
| 1-2 pm | Low current utilization |
| 2-3 pm | Low current utilization |
| 3-4 pm | High current utilization |
| 4-5 pm | High current utilization |
| 5-6 pm | High current utilization |
| 6-7 pm | Low current utilization |
| 7-8 pm | Low current utilization |

In several embodiments, method 400 additionally can include with an activity 450 of assigning the each respective time slot to a respective usage tier of the usage tiers based at least in part on (1) a respective rank of the historic utilization ranking for the each respective time slot, (2) the respective current utilization of the each respective time slot, and (3) the customizable parameters. For example, each of the time slots can be assigned to Tier 1, Tier 2, or Tier 3. In some embodiments, assigning the each respective time slot to the respective usage tier can be further based at least in part on: (1) a first comparison of the respective rank of the each respective time slot with the target split for the usage tiers; (2) a second comparison of the respective current utilization of the each respective time slot with the current utilization threshold; (3) a third comparison of a respective amount of time until closing of the each respective time slot with a first reverse-surge time-duration threshold of the one or more reverse-surge time-duration thresholds associated with a first usage tier (e.g., Tier 1) of the usage tiers; (4) a fourth comparison of the respective amount of time until closing of the each respective time slot with a second reverse-surge time-duration threshold of the one or more reverse-surge time-duration thresholds associated with a second usage tier of the usage tiers, and/or other suitable comparisons and/or factors.

As described above, the first comparison can be used to indicate whether the time slot is high historic utilization or low historic utilization, based on the rank in the historical utilization ranking and the target split. The second comparison can be used to indicate whether the time slot is low current utilization or high historic utilization, based on the current utilization and the current utilization threshold. In several embodiments, as described above, when the time slot only has one opening remaining (or another suitable number remaining), the time slot can be considered super high current utilization. The third comparison can be used to determine if a reverse surge should be implemented to lower the usage tier from Tier 2 to Tier 1 based on the amount of time until closing and the first reverse-surge time-duration threshold. The fourth comparison can be used to determine if a reverse surge should be implemented to lower the usage tier from Tier 3 to Tier 2 based on the amount of time until closing and the second reverse-surge time-duration threshold.

Table 3 shows an example decision tree for determining how to assign a usage tier to a time slot based on the historic utilization, the current utilization, and whether the time slot is nearing closure.

TABLE 3

| Historic | Current | Nearing | Slot Tier to Be |
|---|---|---|---|
| Utilization? | Utilization? | Closure? | Assigned |
| High | High | No | Tier 2 |
| High | Low | No | Tier 2 |
| Low | High | No | Tier 2 |
| Low | Low | No | Tier 1 |
| High | High | Yes | Tier 1 |
| High | Low | Yes | Tier 1 |
| Low | High | Yes | Tier 1 |
| Low | Low | Yes | Tier 1 |
| High or Low | Super High | No | Tier 3 |
| High or Low | Super High | Yes | Tier 2 |

In some embodiments, activity 450 of assigning the each respective time slot to a respective usage tier of the usage tiers can be performed based on the code shown in Algorithm 1 below.

Algorithm 1: Tiering Assignment

if ( (slot_rank > (1 − Target_Split) AND Current_Utilization
< Current_Utilization_Threshold AND NOT Last_Slot) OR
Time_to_Cut_off < Threshold_Tier_1_reverse_surge )

tier = tier_1;

else if ( (NOT Last_Slot) OR (Last_Slot AND Time_to_Cut_off
< Threshold_Tier_2_reverse_surge) )

tier = tier_2;

else

tier = tier_3;

In Algorithm 1, a time slot can be assigned to Tier 1 if the time slot has both low historic utilization and low current utilization. A time slot also can be assigned to Tier 1 if the time slot is nearing closure based on the first reverse-surge time duration parameter for Tier 1. For time slots not assigned to Tier 1, the time slot can be assigned to Tier 2 if the current utilization of the time slot is not super high, or if the time slot is nearing closure based on the second reverse-surge time duration parameter for Tier 2. Otherwise, the time slot can be assigned Tier 3. In other embodiments, other suitable implementation algorithms can be used to assign the usage tiers to the time slots.

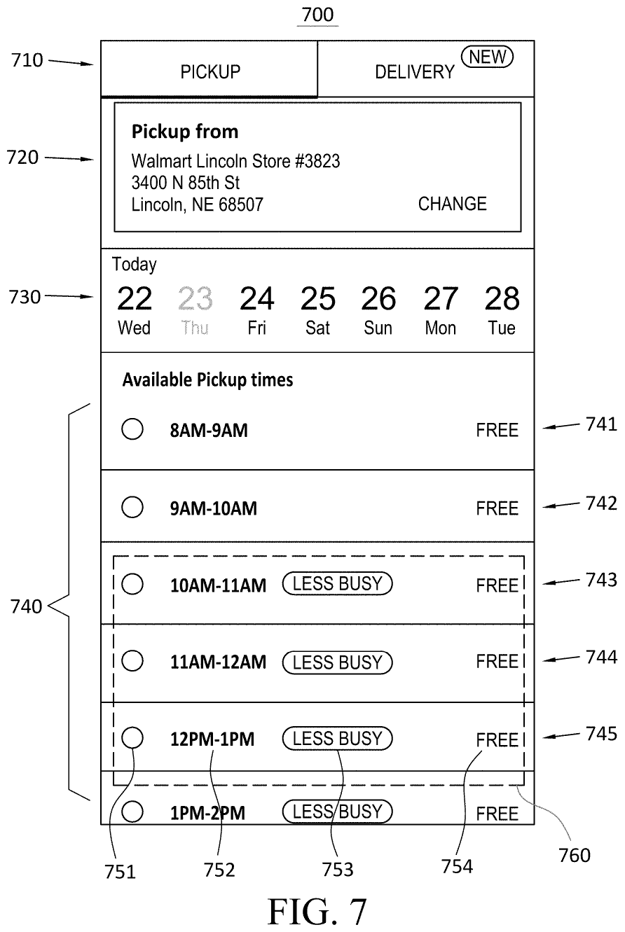

In a number of embodiments, method 400 further can include an activity 460 of facilitating display of a second user interface to a customer. In many embodiments, the customer can be similar or identical to a user, such as user 350 (FIG. 3), who is using web server 320 (FIG. 3) to enter an order to be picked up at the retail store by the customer or a delivery service. In some embodiments, a display of the second user interface can be similar or identical to user interface display 700 (FIG. 7, described below). In several embodiments, the second user interface can include a listing of at least a portion of the pickup time slots and usage indicators associated with individual time slots of the portion of the pickup time slots. In some embodiments, the listing can be similar or identical to time slot listing 740, as shown in FIG. 7 and described below, and/or the usage indicators can be similar or identical to usage indicator 753, as shown in FIG. 7 and described below. In a number of embodiments, the usage indicators can be associated with the individual time slots based on the respective usage tier to which each of the individual time slots have been assigned. In some embodiments, the second user interface further can include the delivery-service pickup prices associated with the individual time slots of the portion of the pickup time slots. In various embodiments, the delivery-service pickup prices can be associated with the individual time slots based on the respective usage tier to which the each of the individual time slots have been assigned.

Turning ahead in the drawings, FIG. 7 illustrates an exemplary user interface display 700 to allow user 350 (FIG. 3), such as a customer, to select a pickup time slot. User interface display 700 is merely exemplary, and embodiments of the user interface display are not limited to the embodiments presented herein. The user interface display can be employed in many different embodiments or examples not specifically depicted or described herein, and can include other suitable elements. In many embodiments, user device 340 (FIG. 3) can display user interface display 700 to user 350 (FIG. 3), which can include a form that allows the user to select a pickup time slot.

In a number of embodiments, user interface display 700 can include a pickup type selector 710, a store descriptor 720, a date selector 730, and/or a time slot listing 740. In some embodiments, pickup type selector 710 can allow the customer to select either pickup or delivery, to indicate whether the customer will be pickup up the order at the retail store, or if the customer instead prefers that a delivery service pick up the order at the retail store and deliver the order to the customer. In many embodiments, store descriptor 720 can include a description of the retail store, such as a name of the store, an address of the store, and/or other suitable information.

In a number of embodiments, date selector 730 can allow the customer to select a date in order to display pickup time slots that are available on that date. For example, the customer can select a date within the current week, starting on the current date or the day after the current date. In a number of embodiments, time slot listing 740 can include time slot options to allow the customer to view information about time slots and/or select time slots that are available on the date selected using date selector 730. For example, as shown in user interface display 700, time slot listing 740 can include a time slot option 741 for 8-9 am, a time slot option 742 for 9-10 am, a time slot option 743 for 10-11 am, a time slot option 744 for 11 am-12 pm, and a time slot option 745 for 12-1 pm.

In a number of embodiments, each time slot option (e.g., 741-745) can include various selectors and/or other information about the time slot associated with the time slot option. For example, time slot option 745 can include a selector 751, a time descriptor 752, a usage indicator 753, a price indicator 754, and/or other suitable information. Selector 751 can be a radio button that allows the customer to select time slot option 745. Time descriptor 752 can display the time range that applies to time slot option 745, such as 12-1 pm. Usage indicator 753 can display the usage indicator (e.g., customer-facing indicator) that applies to the usage tier to which the time slot was assigned in activity 450 (FIG. 4). For example, if the time slot was assigned to Tier 1, the customer-facing indicator of “Less Busy” that was entered by the controlled in customer-facing indicator fields 552 (FIG. 5) can be displayed in usage indicator 753, as shown in user interface display 700 (FIG. 7). Price indicator 754 can display the price that applies to time slot option 745, such as was entered by the controller in price fields 551 (FIG. 5). For example, if the time slot was assigned to Tier 1 and the price associated with Tier 1 is free, then price indicator 754 can display free. If instead the customer selected delivery in pickup type selector 710, and the controller had entered $7.95 as the price for delivery, then price indicator 754 can display $7.95. In many embodiments, once the customer selects a time slot option (e.g., 741-745), such as by using selector 751, the time slot associated with that time slot option can be used for pickup at the store.

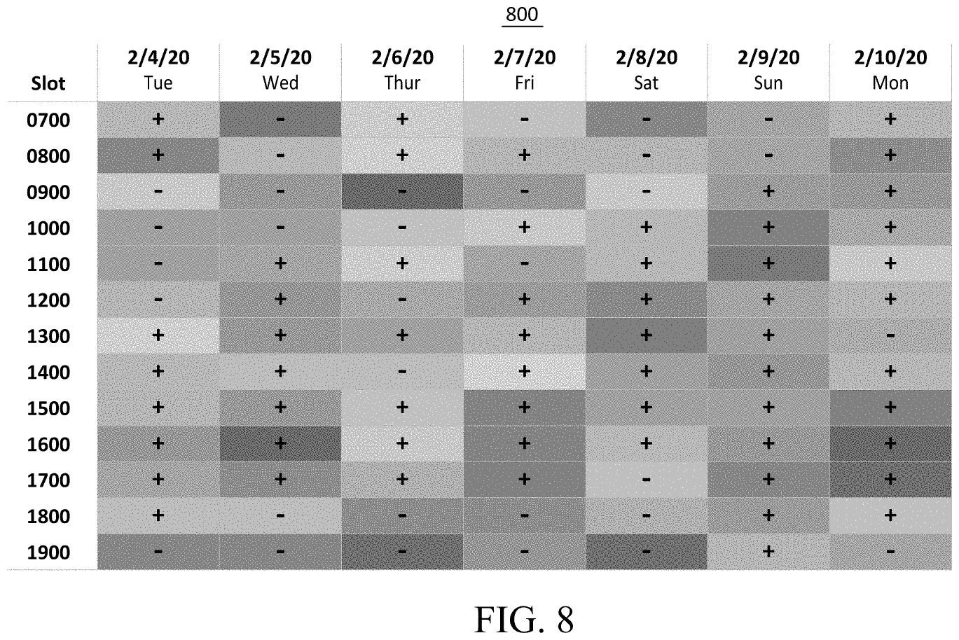

In many embodiments, user interface display 700 can provide messaging to customers to shape demand, such as by making customers aware of less busy time slot and/or by incentivizing the customers with discounts for less busy time slots. For example, as shown in FIG. 7, time slot options 743-745 in box 760 can include the “Less Busy” usage indicator to indicate to customers that those time slots are less busy. By nudging customers to select less busy time slots, such as time slots assigned to Tier 1, demand across time slots during the week can become more balanced due to flexible customers changing to difference time slots, which can allow inflexible customers to be able to select their preferred time slots, even for same-day orders. As explained below, FIGS. 8-13(b) demonstrate how the techniques described herein helped to redistribute the demand more evenly for a retail store that was experiencing uneven demand distribution.

Turning ahead in the drawings, FIG. 8 illustrates a heat map 800 showing historic utilization for each pickup time slot during a particular week for a particular retail store location. Heat map 800 can be similar to heat map 600 (FIG. 6) and can indicate a general level of utilization for each time slot. The time slots that are lower utilized include a “-” to indicate lower usage, with lighter shading indicating low utilization, and darker shading indicating even lower utilization. The time slot that are high utilized include a “+” to indicate higher usage, with lighter shading indicating high utilization and darker shading indicating even higher utilization. Heat map 800 shows the level of utilization for each time slot over the past four weeks. As shown in heat map 800, there are several time slots of very high utilization that are in high demand with customers. There are also several time slots of very low utilization that are in low demand with customers. The techniques described herein were used to shape demand at the retail store to redistribute demand more evenly.

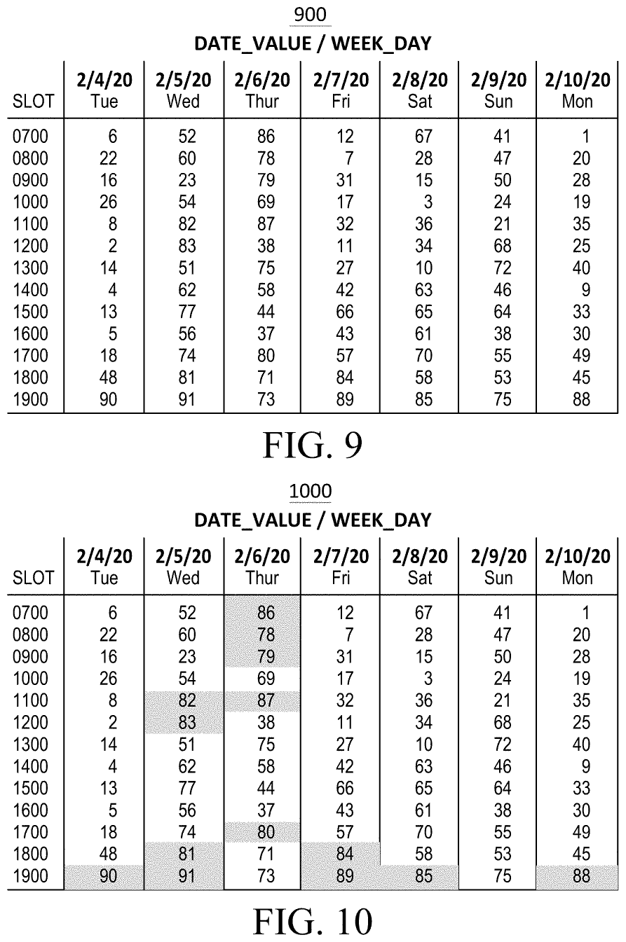

Turning ahead in the drawings, FIG. 9 illustrates a table 900 showing the historic utilization ranking for the time slots shown in heat map 800 (FIG. 8). Table 900 shows a rank, from 1 to 91, for each time slot. The rank of each time slot in the historic utilization ranking can be generated using activity 430 (FIG. 4). Rank 1 means the time slot that is the most utilized on average during the past four weeks at the store location, and rank 91 means the time slot that is the least utilized on average during the past four weeks at the store location.

Proceeding to the next drawing, FIG. 10 illustrates a table 1000 showing the historic utilization ranking shown in table 900 (FIG. 9), with the time slots having low historic utilization highlighted. The level of historic utilization (e.g., low vs. high) for a time slot can be determined based on the target split parameter, as described above. For example, if the target split parameter is set to 15% in target split field 554 (FIG. 5), then the least utilization 15% of the time slots can be the time slots in which the rank of the historical utilization ranking is greater than 100%−15%, which is 85%. The time slot with rank 78 has a percentage of 78/91 within the 91 total time slots, which is 85.7%, so that time slot would be considered to have low historic utilization. As shown in table 1000, ranks 78-91 have low historic utilization.

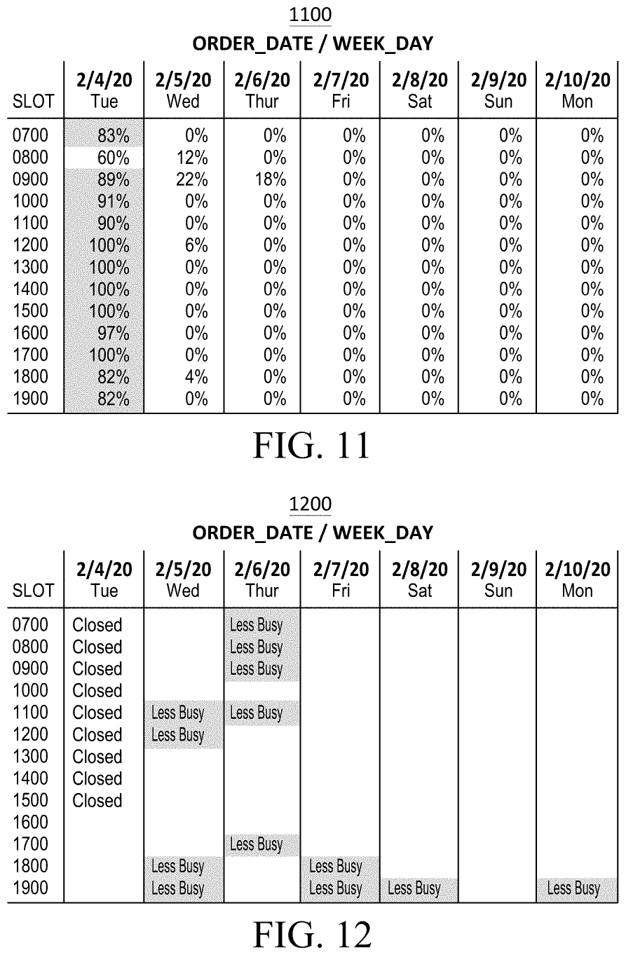

Turning ahead in the drawings, FIG. 11 illustrates a table 1100 showing the current utilization of the same time slots that were shown in FIGS. 8-10, with the time slots having high current utilization highlighted. The current utilization. The current utilization of each time slot can be determined using activity 440 (FIG. 4). The level of current utilization (e.g., low vs. high) for a time slot can be determined based on the current utilization threshold, as described above. For example, if the current utilization threshold is set to 80% in current utilization threshold field 560 (FIG. 5), then the time slots that have current utilization about 80% can be considered as having high current utilization. As shown in FIG. 11, many slots for the current day used in this example, namely Tuesday, Feb. 4, 2020, have already have high current utilization. This information can be based on real-time information based on how many pickups have already been scheduled for the upcoming time slots.

Proceeding to the next drawing, FIG. 12 illustrates a table 1200 showing the time slots of FIG. 11 that are assigned to a first usage tier (e.g., Tier 1) with a usage indicator of “Less Busy.” Time slots that have already closed, as they are within a preset time period, as described above, and/or because they are already fully utilized (e.g., the number of orders equal the capacity for the time slot), can be listed as “Closed.” Once the historic utilization and current utilization have been generated and/or determined, the time slot can be assigned a usage tier. The usage tier can be assigned using activity 450 (FIG. 4). Those time slots that are assigned to Tier 1 are shown in FIG. 11 with the usage indicator of “Less Busy.” These usage indicators can be displayed to the customers, similarly as shown in FIG. 7, which can make customers aware of the time slots in which wait times are likely to be shorter and to nudge customers to choose such time slots that are less busy. There can be significant overlap between the time slots with low historic utilization shown in FIG. 10 and the time slots that are assigned to Tier 1 as shown in FIG. 12. However, as shown in FIG. 12, the time slot at 1900 Hours on Tuesday, Feb. 4, 2020, is not included in Tier 1, even though it has low historic utilization, because that time slot has high current utilization, as shown in FIG. 11.

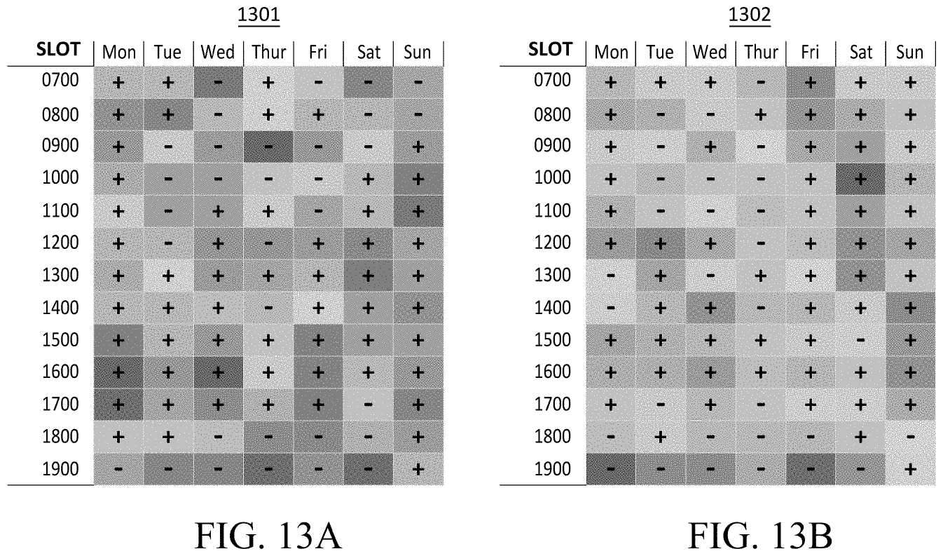

Turning ahead in the drawings, FIG. 13A illustrates a heat map 1301 showing historic utilization for each pickup time slot during a particular week for a particular retail store location before using the techniques described herein. FIG. 13B illustrates a heat map 1302 showing historic utilization for each pickup time slot during a particular week for the retail store location after using the techniques described herein for more than four weeks. Heat maps 1301-1302 can be similar to heat map 600 (FIG. 6) and/or heat map 600 (FIG. 6), and can indicate a general level of utilization for each time slot. The time slots that are lower utilized include a “-” to indicate lower usage, with lighter shading indicating low utilization, and darker shading indicating even lower utilization. The time slot that are high utilized include a “+” to indicate higher usage, with lighter shading indicating high utilization and darker shading indicating even higher utilization. The differences between heat map 1301 and heat map 1302 show that there are fewer time slots with very high historic utilization, which means that both flexible and non-flexible customers generally can obtain time slots at the retail store that are acceptable to them. After implementing these techniques, many customers indicated that they were pleased with knowing time slots that were less busy and that would likely result in shorter wait times.

Returning to FIG. 3, in several embodiments, communication system 311 can at least partially perform activity 410 (FIG. 4) of facilitating display of a first user interface to a controller, activity 420 (FIG. 4) of receiving the customizable parameters from the controller, and/or activity 460 (FIG. 4) of facilitating display of a second user interface to a customer.

In several embodiments, historic utilization system 312 can at least partially perform activity 430 (FIG. 4) of generating a historic utilization ranking corresponding to pickup time slots.

In a number of embodiments, current utilization system 313 can at least partially perform activity 440 (FIG. 4) of determining in real-time a respective current utilization of each respective time slot of the pickup time slots.

In several embodiments, tiering system 314 can at least partially perform activity 450 (FIG. 4) of assigning the each respective time slot to a respective usage tier of the usage tiers based at least in part on (1) a respective rank of the historic utilization ranking for the each respective time slot, (2) the respective current utilization of the each respective time slot, and (3) the customizable parameters.

In a number of embodiments, web server 320 can at least partially perform activity 410 (FIG. 4) of facilitating display of a first user interface to a controller, activity 420 (FIG. 4) of receiving the customizable parameters from the controller, and/or activity 460 (FIG. 4) of facilitating display of a second user interface to a customer.

In many embodiments, the techniques described herein can provide a practical application and several technological improvements. In some embodiments, the techniques described herein can provide for automatic dynamic demand shaping. These techniques described herein can provide a significant improvement over conventional approaches of having unbalanced demand with popular time slots that were often not available for same-day selection.

In many embodiments, the techniques described herein can be used continuously at a scale that cannot be handled using manual techniques. For example, the techniques can be applied to thousands of stores, and the number of time slots that can be handled each week across the stores can exceed a hundred thousand or even a million, and these time slots can be viewed by thousands or millions or customers.

In a number of embodiments, the techniques described herein can solve a technical problem that arises only within the realm of computer networks, as online ordering and selection of time slots for picking up online orders are concepts that do not exist outside the realm of computer networks. Moreover, the techniques described herein can solve a technical problem that cannot be solved outside the context of computer networks. Specifically, the techniques described herein cannot be used outside the context of computer networks, in view of a lack of data.

Various embodiments can include a system including one or more processors and one or more non-transitory computer-readable media storing computing instructions that, when executed on the one or more processors, perform certain acts. The acts can include facilitating display of a first user interface to a controller. The first user interface can include fields that allow the controller to specify customizable parameters for shaping demand. The acts also can include receiving the customizable parameters from the controller. The acts additionally can include generating a historic utilization ranking corresponding to pickup time slots. The acts further can include determining in real-time a respective current utilization of each respective time slot of the pickup time slots. The acts additionally can include assigning the each respective time slot to a respective usage tier of usage tiers based at least in part on (1) a respective rank of the historic utilization ranking for the each respective time slot, (2) the respective current utilization of the each respective time slot, and (3) the customizable parameters. The acts further can include facilitating display of a second user interface to a customer. The second user interface can include a listing of at least a portion of the pickup time slots and usage indicators associated with individual time slots of the portion of the pickup time slots. The usage indicators can be associated with the individual time slots based on the respective usage tier to which each of the individual time slots have been assigned.

A number of embodiments can include a method being implemented via execution of computing instructions configured to run at one or more processors. The method can include facilitating display of a first user interface to a controller. The first user interface can include fields that allow the controller to specify customizable parameters for shaping demand. The method also can include receiving the customizable parameters from the controller. The method additionally can include generating a historic utilization ranking corresponding to pickup time slots. The method further can include determining in real-time respective current utilization of each respective time slot of the pickup time slots. The method additionally can include assigning the each respective time slot to a respective usage tier of usage tiers based at least in part on (1) a respective rank of the historic utilization ranking for the each respective time slot, (2) the respective current utilization of the each respective time slot, and (3) the customizable parameters. The method further can include facilitating display of a second user interface to a customer. The second user interface can include a listing of at least a portion of the pickup time slots and usage indicators associated with individual time slots of the portion of the pickup time slots. The usage indicators can be associated with the individual time slots based on the respective usage tier to which each of the individual time slots have been assigned.

Although the methods described above are with reference to the illustrated flowcharts, it will be appreciated that many other ways of performing the acts associated with the methods can be used. For example, the order of some operations may be changed, and some of the operations described may be optional.

In addition, the methods and system described herein can be at least partially embodied in the form of computer-implemented processes and apparatus for practicing those processes. The disclosed methods may also be at least partially embodied in the form of tangible, non-transitory machine-readable storage media encoded with computer program code. For example, the steps of the methods can be embodied in hardware, in executable instructions executed by a processor (e.g., software), or a combination of the two. The media may include, for example, RAMs, ROMs, CD-ROMs, DVD-ROMs, BD-ROMs, hard disk drives, flash memories, or any other non-transitory machine-readable storage medium. When the computer program code is loaded into and executed by a computer, the computer becomes an apparatus for practicing the method. The methods may also be at least partially embodied in the form of a computer into which computer program code is loaded or executed, such that, the computer becomes a special purpose computer for practicing the methods. When implemented on a general-purpose processor, the computer program code segments configure the processor to create specific logic circuits. The methods may alternatively be at least partially embodied in application specific integrated circuits for performing the methods.

The foregoing is provided for purposes of illustrating, explaining, and describing embodiments of these disclosures. Modifications and adaptations to these embodiments will be apparent to those skilled in the art and may be made without departing from the scope or spirit of these disclosures.

Although automatic dynamic demand shaping has been described with reference to specific embodiments, it will be understood by those skilled in the art that various changes may be made without departing from the spirit or scope of the disclosure. Accordingly, the disclosure of embodiments is intended to be illustrative of the scope of the disclosure and is not intended to be limiting. It is intended that the scope of the disclosure shall be limited only to the extent required by the appended claims. For example, to one of ordinary skill in the art, it will be readily apparent that any element of FIGS. 1-13(b) may be modified, and that the foregoing discussion of certain of these embodiments does not necessarily represent a complete description of all possible embodiments. For example, one or more of the procedures, processes, or activities of FIG. 4 may include different procedures, processes, and/or activities and be performed by many different modules, in many different orders. As another example, the systems within system 300 in FIG. 3 can be interchanged or otherwise modified.

Replacement of one or more claimed elements constitutes reconstruction and not repair. Additionally, benefits, other advantages, and solutions to problems have been described with regard to specific embodiments. The benefits, advantages, solutions to problems, and any element or elements that may cause any benefit, advantage, or solution to occur or become more pronounced, however, are not to be construed as critical, required, or essential features or elements of any or all of the claims, unless such benefits, advantages, solutions, or elements are stated in such claim.

Moreover, embodiments and limitations disclosed herein are not dedicated to the public under the doctrine of dedication if the embodiments and/or limitations: (1) are not expressly claimed in the claims; and (2) are or are potentially equivalents of express elements and/or limitations in the claims under the doctrine of equivalents.

What is claimed is:

1. A system comprising:
one or more processors; and
one or more non-transitory computer-readable media storing computing instructions that, when executed on the one or more processors, perform:
facilitating display of a first user interface to a controller, wherein the first user interface comprises fields that allow the controller to specify customizable parameters for shaping demand;
receiving the customizable parameters from the controller;
generating a historic utilization ranking corresponding to pickup time slots;
determining in real-time a respective current utilization of each respective time slot of the pickup time slots;
assigning the each respective time slot to a respective usage tier of usage tiers based at least in part on (1) a respective rank of the historic utilization ranking for the each respective time slot, (2) the respective current utilization of the each respective time slot, and (3) the customizable parameters; and
facilitating display of a second user interface to a customer, wherein the second user interface comprises a listing of at least a portion of the pickup time slots and usage indicators associated with individual time slots of the portion of the pickup time slots, and wherein the usage indicators are associated with the individual time slots based on the respective usage tier to which each of the individual time slots have been assigned.

2. The system of claim 1, wherein the historic utilization ranking is generated weekly.

3. The system of claim 1, wherein:
the historic utilization ranking is generated based on a respective utilization of the each respective time slot of the pickup time slots during previous time periods; and
the previous time periods comprise at least four weeks.

4. The system of claim 3, wherein the respective utilization of the each respective time slot of the pickup time slots is determined based on a quantity of orders received for the each respective time slot during the previous time periods and an order capacity at the each respective time slot during the previous time periods.

5. The system of claim 1, wherein the first user interface further comprises fields that allow the user to specify the usage indicators and delivery-service pickup prices for the usage tiers.

6. The system of claim 5, wherein:
the second user interface further comprises the delivery-service pickup prices associated with the individual time slots of the portion of the pickup time slots; and
the delivery-service pickup prices are associated with the individual time slots based on the respective usage tier to which the each of the individual time slots have been assigned.

7. The system of claim 1, wherein the customizable parameters comprise:
a target split for the usage tiers;
one or more reverse-surge time-duration thresholds; and
a current utilization threshold.

8. The system of claim 7, wherein assigning the each respective time slot to the respective usage tier is further based at least in part on:
a first comparison of the respective rank of the each respective time slot with the target split for the usage tiers;
a second comparison of the respective current utilization of the each respective time slot with the current utilization threshold; and
a third comparison of a respective amount of time until closing of the each respective time slot with a first reverse-surge time-duration threshold of the one or more reverse-surge time-duration thresholds associated with a first usage tier of the usage tiers.

9. The system of claim 8, wherein assigning the each respective time slot to the respective usage tier is further based at least in part on a fourth comparison of the respective amount of time until closing of the each respective time slot with a second reverse-surge time-duration threshold of the one or more reverse-surge time-duration thresholds associated with a second usage tier of the usage tiers.

10. The system of claim 1, wherein:
the respective current utilization of the each respective time slot of the pickup time slots is determined based on a quantity of orders already received for the each respective time slot to be filled at the each respective time slot during an upcoming first time period and an order capacity at the each respective time slot during the upcoming first time period; and
the upcoming first time period is approximately one week.

11. A method being implemented via execution of computing instructions configured to run at one or more processors, the method comprising:
facilitating display of a first user interface to a controller, wherein the first user interface comprises fields that allow the controller to specify customizable parameters for shaping demand;
receiving the customizable parameters from the controller;
generating a historic utilization ranking corresponding to pickup time slots;
determining in real-time a respective current utilization of each respective time slot of the pickup time slots;
assigning the each respective time slot to a respective usage tier of usage tiers based at least in part on (1) a respective rank of the historic utilization ranking for the each respective time slot, (2) the respective current utilization of the each respective time slot, and (3) the customizable parameters; and
facilitating display of a second user interface to a customer, wherein the second user interface comprises a listing of at least a portion of the pickup time slots and usage indicators associated with individual time slots of the portion of the pickup time slots, and wherein the usage indicators are associated with the individual time slots based on the respective usage tier to which each of the individual time slots have been assigned.

12. The method of claim 11, wherein the historic utilization ranking is generated weekly.

13. The method of claim 11, wherein:
the historic utilization ranking is generated based on a respective utilization of the each respective time slot of the pickup time slots during previous time periods; and
the previous time periods comprise at least four weeks.

14. The method of claim 13, wherein the respective utilization of the each respective time slot of the pickup time slots is determined based on a quantity of orders received for the each respective time slot during the previous time periods and an order capacity at the each respective time slot during the previous time periods.

15. The method of claim 11, wherein the first user interface further comprises fields that allow the user to specify the usage indicators and delivery-service pickup prices for the usage tiers.

16. The method of claim 15, wherein:
the second user interface further comprises the delivery-service pickup prices associated with the individual time slots of the portion of the pickup time slots; and
the delivery-service pickup prices are associated with the individual time slots based on the respective usage tier to which the each of the individual time slots have been assigned.

17. The method of claim 11, wherein the customizable parameters comprise:
a target split for the usage tiers;
one or more reverse-surge time-duration thresholds; and
a current utilization threshold.

18. The method of claim 17, wherein assigning the each respective time slot to the respective usage tier is further based at least in part on:
a first comparison of the respective rank of the each respective time slot with the target split for the usage tiers;
a second comparison of the respective current utilization of the each respective time slot with the current utilization threshold; and
a third comparison of a respective amount of time until closing of the each respective time slot with a first reverse-surge time-duration threshold of the one or more reverse-surge time-duration thresholds associated with a first usage tier of the usage tiers.

19. The method of claim 18, wherein assigning the each respective time slot to the respective usage tier is further based at least in part on a fourth comparison of the respective amount of time until closing of the each respective time slot with a second reverse-surge time-duration threshold of the one or more reverse-surge time-duration thresholds associated with a second usage tier of the usage tiers.

20. The method of claim 11, wherein:
the respective current utilization of the each respective time slot of the pickup time slots is determined based on a quantity of orders already received for the each respective time slot to be filled at the each respective time slot during an upcoming first time period and an order capacity at the each respective time slot during the upcoming first time period; and
the upcoming first time period is approximately one week.
